(19) United States
(12) Patent Application Publication
(10) Pub. No.: US 2016/0282613 A1
(43) Pub. Date: Sep. 29, 2016

(54) ZOOM LENS APPARATUS AND METHOD OF CONTROLLING SAME

(71) Applicant: FUJIFILM Corporation, Tokyo (JP)

(72) Inventor: Yoshiaki ISHII, Saitama-shi (JP)

(73) Assignee: FUJIFILM Corporation, Tokyo (JP)

(21) Appl. No.: 15/080,975

(22) Filed: Mar. 25, 2016

(30) Foreign Application Priority Data
Mar. 26, 2015 (JP) 2015-064584

(51) Int. Cl. G02B 27/00; G03B 5/06; G02B 7/10

(52) U.S. Cl. CPC G02B 27/0025; G02B 7/10; G03B 5/06

(57) ABSTRACT

Provided are a zoom lens apparatus as well as a method of controlling the apparatus for alleviating astigmatism. A lens is moved along the direction of the optical axis of the zoom lens apparatus in accordance with zoom magnification. The angle of rotation of a ring that rotates about the optical axis of the zoom lens apparatus is read from a table stored in advance. The ring is rotated through the read angle of rotation. A lens holding frame holding the lens has a surface is contact with the ring, and the surface has protrusions and cavities so that when the ring is rotated, the lens holding frame is tilted and so is the lens. The tilt angle is decided in such a manner that astigmatism is reduced in accordance with zoom magnification. Astigmatism is reduced even though the lens is moved in accordance with zoom magnification.

### CROSS-REFERENCE TO RELATED APPLICATIONS

The present invention claims priority under 35 U.S.C. §119 to Japanese Patent Application No. 2015-064584 filed Mar. 5, 2015. Each of the above application(s) is hereby expressly incorporated by reference, in its entirety, into the present application.

### BACKGROUND OF THE INVENTION

1. Field of the Invention

This invention relates to a zoom lens apparatus and to a method of controlling such apparatus.

2. Description of the Related Art

There are instances where aberration occurs in a zoom lens apparatus in the process of manufacturing and assembling the lens. Even if it is attempted to suppress fluctuating aberration by an adjustment performed at the time of assembly of the zoom lens, with a zoom lens used in a very high-definition television broadcast, there are cases where astigmatism, which accompanies zooming, occurs on the order of 0.1 in terms of Newton's rings, thereby resulting in degraded image quality. Further, there is also an arrangement in which a correction of optical axis is performed by a corrective adjustment mechanism for a lens optical system (Patent Document 1).

Patent Document 1: Japanese Patent Application Laid-Open No. 6-51179

With the corrective adjustment mechanism for a lens optical system set forth in Patent Document 1, a method in which performance is satisfied by performing a rotational adjustment at the time of assembly is described. However, no consideration is given to correcting for a change in aberration that accompanies zooming.

### SUMMARY OF THE INVENTION

An object of the present invention is to alleviate astigmatism that accompanies zooming.

The present invention provides a zoom lens apparatus that includes multiple lens groups each constituted by two or more lenses, comprising: a lens tilting mechanism for tilting at least one lens of the two or more lenses constituting the lens group; a lens-group driving mechanism for moving at least one lens group, among the multiple lens groups included in the zoom lens apparatus, along the direction of an optical axis of the zoom lens apparatus in accordance with zoom magnification; and a control mechanism for causing the lens tilting mechanism to tilt the at least one lens at a tilt angle that corresponds to the zoom magnification.

The present invention provides also a method of controlling a zoom lens apparatus. Specifically, the present invention provides a method of controlling a zoom lens apparatus that includes multiple lens groups each constituted by two or more lenses, comprising steps of: a lens tilting mechanism tilting at least one lens of the two or more lenses constituting the lens group; a lens-group driving mechanism moving at least one lens group, among the multiple lens groups included in the zoom lens apparatus, along the direction of an optical axis of the zoom lens apparatus in accordance with zoom magnification; and a control mechanism causing the lens tilting mechanism to tilt the at least one lens at a tilt angle that corresponds to the zoom magnification.

The apparatus may further comprise a tilt-angle detection device (tilt-angle detection means) for detecting the tilt angle of the at least one lens tilted by the lens tilting mechanism. In this case the control mechanism controls the lens tilting mechanism in such a manner that the tilt angle detected by the tilt-angle detection device takes on a tilt angle that corresponds to the zoom magnification.

The control mechanism has a cam mechanism for tilting the at least one lens at the tilt angle that corresponds to the zoom magnification.

By way of example, the cam mechanism includes: a lens holding frame for holding the at least one lens; and a ring, which has a surface in contact with the surface of the lens holding frame and rotates through a rotational angle, which corresponds to the zoom magnification, about the optical axis of the zoom lens apparatus; wherein at least one of the surface of the lens holding frame or surface of the ring has a cam for providing the lens holding frame with motion that tilts the at least one lens at the tilt angle that corresponds to the zoom magnification.

By way of example, the lens tilting mechanism tilts the at least one lens about an axis which is at least one of a first axis and a second axis that are both orthogonal to the optical axis of the zoom lens apparatus and orthogonal to each other. Further, by way of example, the control mechanism controls the lens tilting mechanism to thereby tilt the at least one lens about the first axis at a first tilt angle that corresponds to the zoom magnification and tilt the at least one lens about the second axis at a second tilt angle that corresponds to the zoom magnification.

The apparatus may further comprise a first tilt-angle detection device (first tilt-angle detection means) for detecting the tilt angle of the at least one lens tilted by the lens tilting mechanism about the first axis; and a second tilt-angle detection device (second tilt-angle detection means) for detecting the tilt angle of the at least one lens tilted by the lens tilting mechanism about the second axis. In this case, the control mechanism, by controlling the lens tilting mechanism, adopts the detection angle, which has been detected by the first tilt-angle detection device, as the first tilt angle that corresponds to the zoom magnification, and by controlling the lens tilting mechanism, adopts the detection angle, which has been detected by the second tilt-angle detection device, as the second tilt angle that corresponds to the zoom magnification.

By way of example, the control mechanism has a cam mechanism for tilting the at least one lens about the first axis at the first tilt angle that corresponds to the zoom magnification and tilting the at least one lens about the second axis at the second tilt angle that corresponds to the zoom magnification.

By way of example, the cam mechanism includes: a lens holding frame for holding the at least one lens; and a ring, which has a surface in contact with the surface of the lens holding frame and rotates through a rotational angle, which corresponds to the zoom magnification, about the optical axis of the zoom lens apparatus; wherein at least one of the surface of the lens holding frame or surface of the ring has a cam for providing the lens holding frame with motion that tilts the at least one lens about the first axis at the first tilt angle that corresponds to the zoom magnification and that tilts the at least one lens about the second axis at the second tilt angle that corresponds to the zoom magnification.

The lens tilting mechanism may further have: a first lens holding frame freely tiltable about the first axis for holding the at least one lens; and a second lens holding frame holding the first lens holding frame in a freely tiltable manner at a portion on the first axis, and being freely tiltable about the second axis.

The apparatus may further comprise a supporting member for supporting the at least one lens at one end thereof in freely swinging fashion. In this case, by way of example, the control mechanism includes a linear motion mechanism which, by moving the at least one lens along the optical axis, tilts the at least one lens at the tilt angle that corresponds to the zoom magnification, with the supporting member serving as a fulcrum.

By way of example, the control mechanism includes: a first linear motion mechanism for tilting the at least one lens about the first axis at the first tilt angle that corresponds to zoom magnification by moving the at least one lens along the direction of the optical axis at a first portion thereof different from a portion thereof on the first axis; and a second linear motion mechanism for tilting the at least one lens about the second axis at the second tilt angle that corresponds to zoom magnification by moving the at least one lens along the direction of the optical axis at a second portion thereof different from a portion thereof on the second axis.

By way of example, preferably the at least one lens is situated between a diaphragm and an image forming plane of a subject.

In accordance with the present invention, at least one lens is tilted (with respect to the optical axis of the zoom lens apparatus) at a tilt angle corresponding to the zoom magnification. Even if a group of zoom lenses moves along the optical axis in accordance with the zoom magnification, the lenses can be tilted at such a tilt angle for which astigmatism is mitigated in accordance with movement of the lenses. Astigmatism can be reduced irrespective of the zoom magnification.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of a television lens system;

FIG. 2 is a partial sectional view of a zoom lens apparatus;

FIG. 3 is a perspective view of a lens holding frame and ring;

FIG. 4 is a perspective view of the lens holding frame;

FIG. 5 is a back view of the lens holding frame;

FIG. 6 is a front view of a rotary body;

FIG. 7 is a back view of the rotary body;

FIG. 8 is a table illustrating the relationship among zoom magnification, rotational angle and tilt angle;

FIG. 9 is a table illustrating the relationship among zoom magnification, rotational angle, first tilt angle and second tilt angle;

FIG. 10 is a flowchart illustrating processing executed by the television lens apparatus;

FIG. 11 is a perspective view of a zoom lens apparatus;

FIG. 12 is a sectional view taken along line XII-XII of FIG. 11;

FIG. 13 is a sectional view taken along line XIII-XIII of FIG. 11;

FIG. 14 is a back view of a lens holding body;

FIG. 15 is a table illustrating the relationship among zoom magnification, first tilt angle and second tilt angle; and

FIG. 16 is a flowchart illustrating processing executed by the television lens apparatus.

### DESCRIPTION OF THE PREFERRED EMBODIMENTS

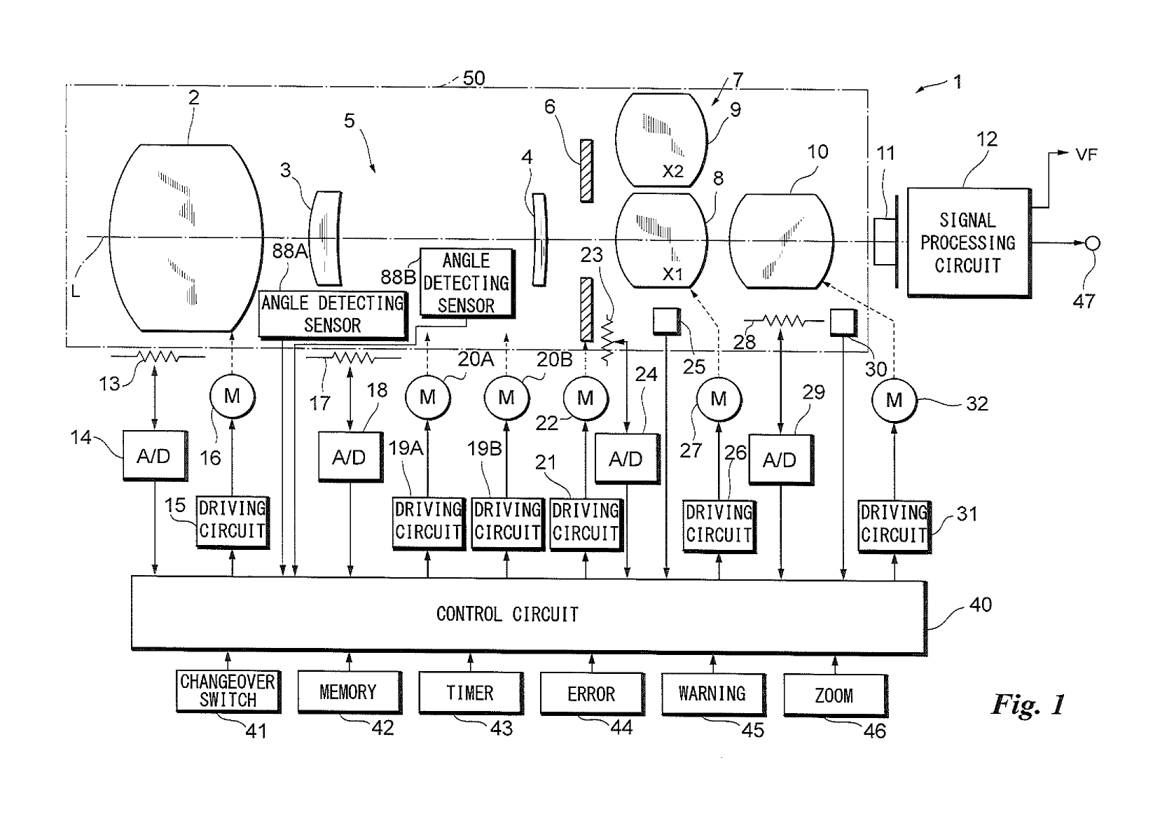

FIG. 1 is a block diagram illustrating the electrical configuration of a lens (zoom lens apparatus) 1 for a television camera having a zoom lens barrel.

The overall operation of the lens 1 for the television camera is controlled by a control circuit 40.

The TV camera lens 1 includes an image sensor 11. A zoom lens barrel 50 is disposed on the side of the photoreceptor surface of the image sensor 11. Placed in the zoom lens barrel 50 are a focusing optical system 2 that includes one lens or multiple lenses (the focusing optical system 2 also is a lens group constituted by two or more lenses); a zoom optical system (a lens group constituted by two or more lenses) 5 for changing zoom magnification; a diaphragm 6; an extender lens (group) 7 and a master optical system 10 (the master optical system 10 also is a lens group constituted by two or more lenses). The TV camera lens 1 has an optical axis L that passes through the centers of the focusing optical system 2, zoom optical system 5, diaphragm 6, master optical system 10 and photoreceptor surface of the image sensor 11. The zoom optical system 5 is constituted by one or multiple variable power lenses 3 and one or multiple corrective lenses 4. The extender lens 7 includes an imaging lens 8 having an imaging magnification of 1× and an imaging lens 9 having an imaging magnification of 2× that are mounted on a turret plate (not shown). The turret plate of the extender lens 7 rotates in response to a changeover control signal from a changeover switch 41, whereupon either the 1× imaging lens 8 or 2× imaging lens 9 is positioned on the optical axis L.

The lens position of the lens included in the focusing optical system 2 is detected by a detector 13. A detection signal indicating the lens position of the lens included in the focusing optical system 2 detected by the detector 13 is input to the control circuit 40 upon being converted to digital detection data by an analog/digital conversion circuit 14. The user sets amount of focus by turning a focusing ring (not shown). The control circuit 40 compares the set amount of focus with the lens position of the lens included in the focusing optical system 2 represented by the digital detection data detected and, based upon the compared values, generates data indicating amount of drive of the lens included in the focusing optical system 2. The generated data indicating amount of drive is applied to a driving circuit 15. A focusing motor 16 is controlled by the driving circuit 15, whereby the lens position of the lens included in the focusing optical system 2 is adjusted.

The variable power lens 3 (a lens group consisting of two or more lenses) constituting the zoom optical system 5 varies the focal length, and the corrective lens 4 (a lens group consisting of two or more lenses) applies a correction in such a manner that the focal-point position will not shift. When a zoom command from a zoom button 46 is applied to the control circuit 40, a driving circuit 19A is controlled by the control circuit 40 and rotates a motor 20A. At least one of the variable power lens 3 and corrective lens 4 is moved along the optical axis L by the motor 20A. Naturally, by rotating a zoom cam cylinder (not shown) that rotates in accordance with rotation of a zoom ring (not shown) manipulated by the user, the variable power lens 3 and corrective lens 4 may be moved on the optical axis L with a fixed relationship between them. The positions of the variable power lens 3 and corrective lens 4, which constitute the zoom optical system 5, along the direction of the optical axis are detected by a detector 17. The detection signal that is output from the detector 17 is input to the control circuit 40 upon being converted to digital detection data by an analog/digital conversion circuit 18. The control circuit 40 compares the amount of zoom set by the zoom ring with the lens position of the lens included in the zoom optical system 5 represented by the digital detection data detected and, based upon the compared values, generates data indicating amount of drive of the lens included in the zoom optical system 5. The generated data indicating amount of zoom is applied to the driving circuit 19. A zoom motor 20 is controlled by the driving circuit 19, whereby the lens positions of the variable power lens 3 and corrective lens 4 constituting the zoom optical system 5 are adjusted. Although one variable power lens 3 and one corrective lens 4 are illustrated in FIG. 1, it goes without saying that a plurality of each may exist. Multiple detectors 17 are provided as necessary in correspondence with the plurality of lenses and undergo the control described above.

Furthermore, in this embodiment, the lens (at least one lens of two or more lenses that constitute the zoom lens group) included in the zoom optical system 5 can be tilted (tilted by being twisted with respect to the optical axis L of the zoom lens barrel 50) in such a manner that the optical axis of the lens tilts with respect to the optical axis L of the zoom lens barrel 50. To achieve this, the TV camera lens 1 includes a driving circuit 19B and a motor 20B. By driving the motor 20B by the driving circuit 19B, the desired lens included in the zoom optical system 5 can be tilted with respect to the optical axis L.

The amount of aperture of diaphragm 6 is detected by a detector 23. The detector 23 outputs a detection signal that is input to the control circuit 40 upon being converted to digital detection data by an analog/digital conversion circuit 24. Further, data indicating amount of drive is generated in accordance with the angle of rotation of a diaphragm ring (not shown) manipulated by the user. The control circuit 40 compares the generated data indicating amount of drive with data indicating the detected amount of drive and, based upon the compared values, generates data indicating amount of drive of the diaphragm 6. The generated data indicating amount of drive is applied to a driving circuit 21. A diaphragm motor 22 is controlled by the driving circuit 21, whereby the diaphragm 6 is set to the desired aperture value.

Provided in the vicinity of the extender lens 7 is a photo-interrupter (detector) 25 for detecting which of the imaging lenses 8 and 9 constituting the extender lens 7 has been positioned on the optical axis L. The output signal of the photo-interrupter 25 is input to the control circuit 40, which detects whether the imaging lens 8 or 9 designated by the changeover switch 41 has been positioned on the optical axis L. If the imaging lens 8 or 9 designated by the changeover switch 41 has not been positioned on the optical axis L, driving data is generated by the control circuit 40 and applied to a driving circuit 26 so as to position the designated imaging lens 8 or 9 on the optical axis L. An extender motor 27 is controlled by the driving circuit 26 to position the imaging lens 8 or 9 on the optical axis L.

A flange-back adjustment knob 30 is provided for setting the amount of adjustment of the master optical system 10 consisting of two or more lenses. Data indicating the amount of adjustment set by the knob 30 is input to the control circuit 40. Further, a detection signal that is output from a potentiometer (detector) 28 that detects the amount of movement of the master optical system 10 is input to an analog/digital conversion circuit 29, the signal is converted to digital detection data and the data is input to the control circuit 40. The data indicating the amount of adjustment set by the knob 30 and the digital detection data indicating the amount of movement of the master optical system 10 are compared in the control circuit 40 and driving data is generated based upon the compared values. The generated driving data is applied to a driving circuit 31 to drive a master lens motor 32. By moving the master optical system 10 along the optical axis L, a focusing correction is performed so as to bring the image of the subject into focus on the imaging plane of the image sensor 11.

A video signal that is output from the image sensor 11 is input to a signal processing circuit 12 and is subjected to signal processing such as sampling processing, a white balance adjustment and a gamma correction, whereby a television signal is generated. The generated television signal is output to a viewfinder, where the signal is reproduced, and is applied to an output terminal 47.

Further connected to the control circuit 40 are a memory 42, a timer 43 for measuring date and time, an error LED 44 which, when a malfunction occurs in the optical system constituting the TV camera lens 1, emits light to notify the user of the malfunction, and a warning LED 45 which, when there is increased likelihood that a malfunction will occur, emits light to warn the user. As will be described in detail below, the control circuit 40 controls a lens tilting mechanism so as to tilt at least one lens at a tilt angle that corresponds to zoom magnification.

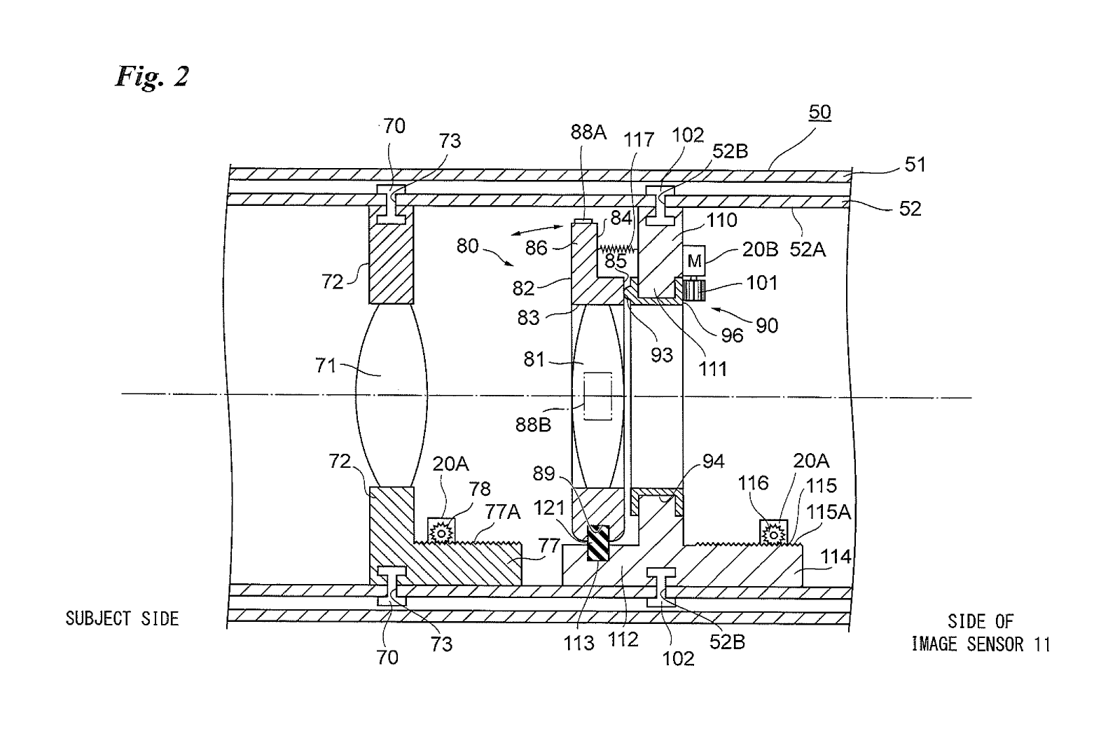

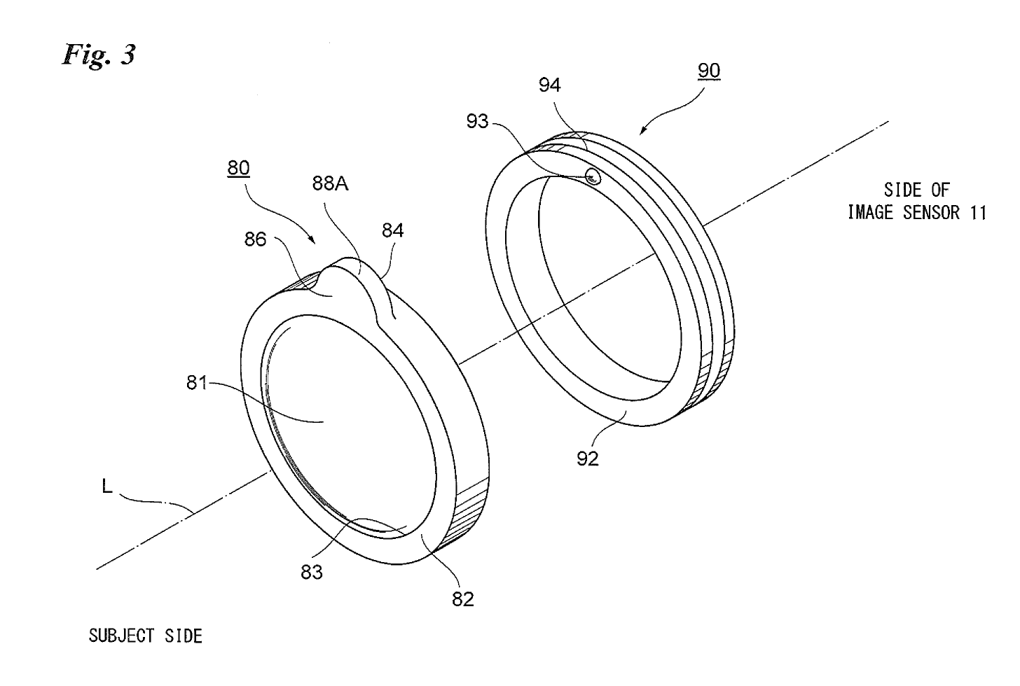

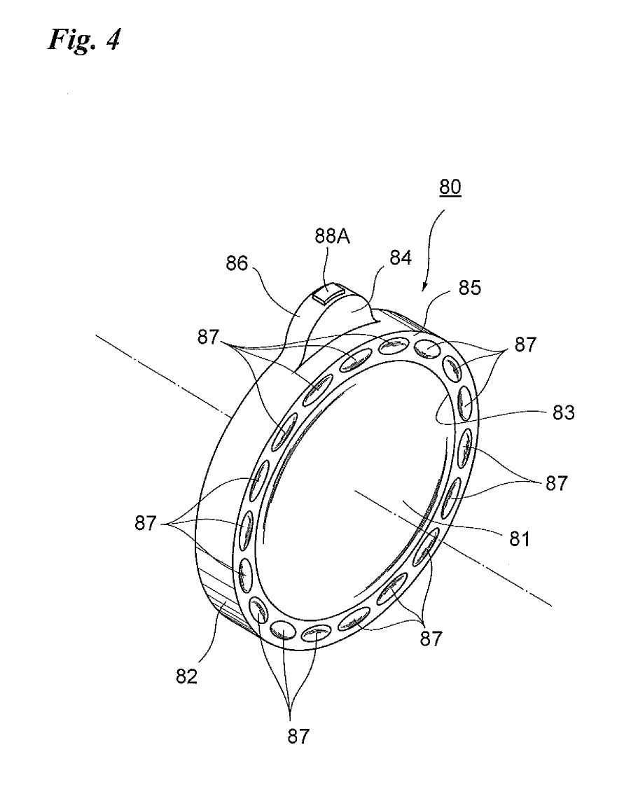

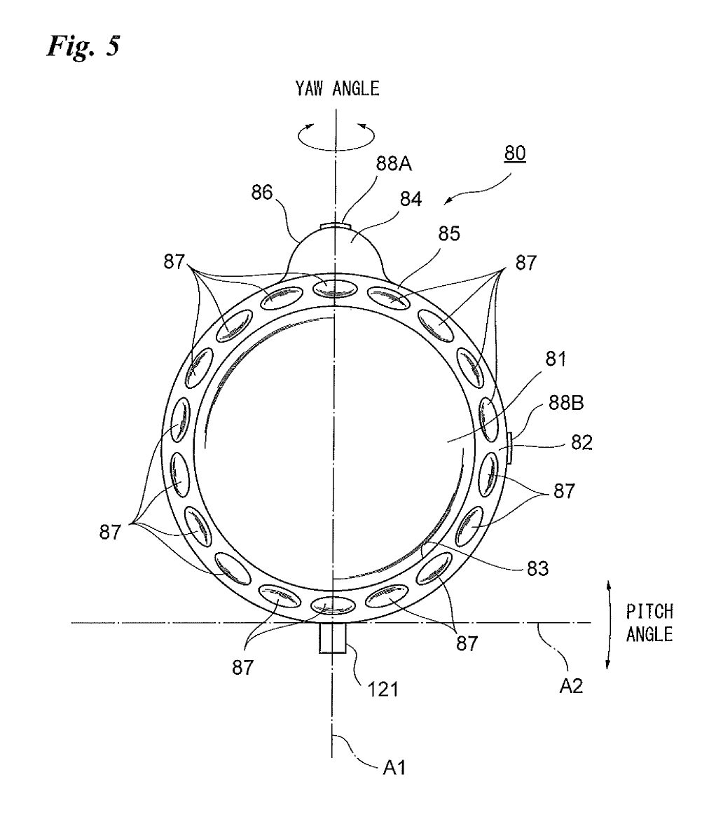

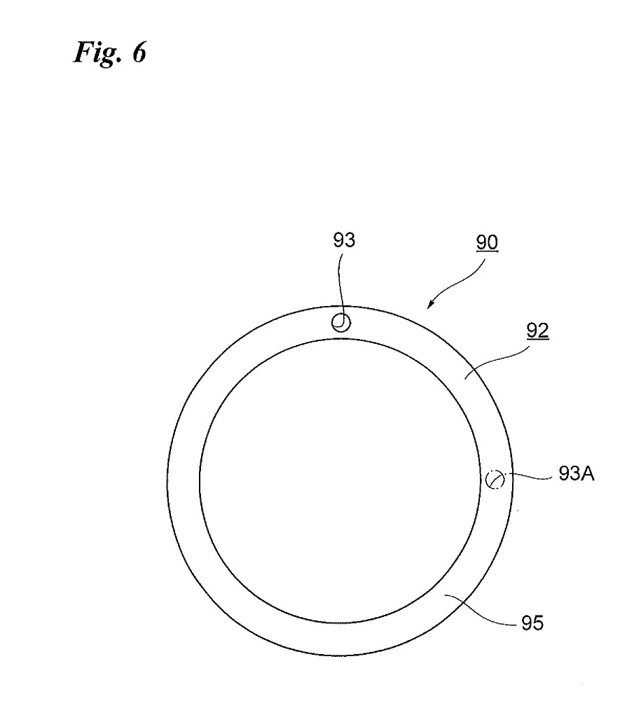

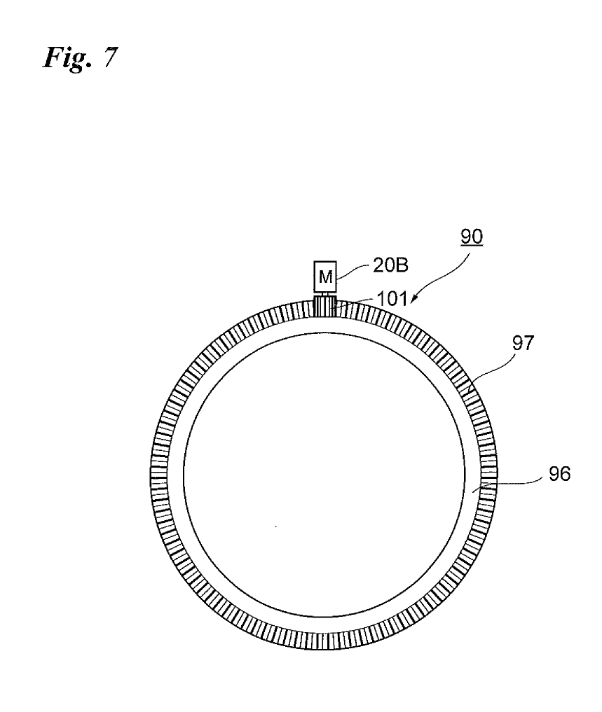

FIG. 2 is a partial sectional view of the zoom optical system 5 included in the zoom lens barrel 50, FIG. 3 an exploded perspective view illustrating a lens holding body 80 and rotary body 90 included in the zoom optical system 5, FIG. 4 a perspective view of the lens holding frame lens holding body 80 as seen from the side of the image sensor 11, FIG. 5 a back view of the lens holding body 80 as seen from the side of the image sensor 11, FIG. 6 a front view of the rotary body 90 as seen from the side of the subject, and FIG. 7 a back view of the rotary body 90 as seen from the side of the image sensor 11.

The zoom lens barrel 50 includes an outer cylinder 51 and an inner cylinder 52.

The lens holding body 80 includes an annular lens holding frame 82. At least one lens 81 is held by the lens holding frame 82. The lower portion of the lens holding frame 82 is formed to have a hole 89 of prescribed depth extending from the outer peripheral surface of the lens holding frame 82 toward the center thereof. A resilient body 121 of rubber or the like is fitted into the hole 89 and protrudes from the hole 89 to the exterior of the lens holding frame 82 (i.e., downward). The portion of the resilient body 121 protruding to the exterior of the lens holding frame 82 is fitted into a hole 113 formed in a pedestal 114 that slides along the direction of the optical axis L, as will be described later. The lens holding body 80 is such that the optical axis of the lens 81 can be tilted with respect to the optical axis L of the zoom lens barrel 50 with the resilient body 121 serving as the fulcrum.

The upper portion of the lens holding frame 82 is formed to have a portion 86 of reduced thickness that is thinner than the rest of the frame. The first angle detecting sensor 88A (first angle detection device) for detecting the twist inclination (yaw angle) of the lens 81 is secured to the upper portion of the thin portion 86. Further, as shown in FIG. 5, the second angle detecting sensor 88B (second angle detection device) for detecting the tilt angle (pitch angle) of the lens 81 is secured to the outer peripheral surface of the lens holding frame 82 on the right side thereof when the lens holding frame 82 is viewed from back side on the side of the image sensor 11. An inner wall (the inner wall at the upper portion in FIG. 2) 52A of the inner cylinder 52 of zoom lens barrel 50, which inner wall opposes the angle detecting sensor 88A, is formed to have a plurality of lines perpendicular to the optical axis L. Further, an inner wall (an inner wall in the foreground of FIG. 2) 52A of the zoom lens barrel 50, which inner wall opposes the second angle detecting sensor 88B, is formed to have a plurality of lines perpendicular to the optical axis L.

The lens holding body 80 can be tilted about a first axis A1 perpendicular to the optical axis L of the zoom lens barrel 50 and extending vertically in FIG. 5. The angle of inclination of the straight lines formed in the inner wall of the inner cylinder 52 is detected by the first angle detecting-sensor 88A, whereby the tilt angle (yaw angle) of the lens holding body 80 (lens 81), which tilts about the first axis A1, is detected. Further, the lens holding body 80 can be tilted about a second axis A2 perpendicular to the optical axis L of the zoom lens barrel 50 and extending horizontally in FIG. 5. The angle of inclination of the straight lines formed in the inner wall of the inner cylinder 52 is detected by the second angle detecting sensor 88B, whereby the tilt angle (pitch angle) of the lens holding body 80 (lens 81), which tilts about the second axis A2, is detected.

One end of a tension spring 117 is secured to an end face 84 of the thin portion 86 on the side of the rotary body 90. The other end of the tension spring 117 is secured to one end face 110A of a slide frame 110 that slides freely in the direction of the optical axis L along the inner wall of the inner cylinder 52. The lens holding body 80 is pulled toward the rotary body 90 by the tension spring 117.

With reference primarily to FIGS. 4 and 5, an end face 85 of the lens holding frame 82 on the side facing the image sensor 11 is formed to have a plurality of protrusions and cavities 87 along the circumferential direction. The protrusions of the protrusions and cavities 87 project from the end face toward the side of the image sensor 11 and the cavities of the protrusions and cavities 87 are recessed within the end face 85. The protrusions and cavities 87 are cams that provide the lens holding frame 82 with motion for tilting at least one lens at a tilt angle corresponding the zoom magnification.

With reference primarily to FIGS. 6 and 7, the rotary body 90 is a ring 92. As shown in FIGS. 2 and 6, an end face 95 of the ring 92 on the side facing the subject is formed to have a protrusion 93 protruding toward the subject side. The protrusion 93 contacts the protrusions and cavities 87 of the lens holding frame 82. As shown in FIG. 7, an end face 96 of the ring 92 on the side facing the image sensor 11 is formed to have a gear 97 (worm wheel) along the circumferential direction. Secured to the gear 97 is a gear wheel 101 (worm gear) fixed to the shaft of the motor 20B (the motor 20B is secured to an end face of the slide frame 110). The gear wheel 101 is in mesh with the gear 97. The rotary body 90 rotates when the shaft of the motor 20B rotates.

With reference to FIGS. 2 and 3, the side face of the ring 92 is formed to have a groove 94 along the circumferential direction. The slide frame 110 has a projection 111 inserted into the groove 94. The ring 92 rotates freely in the circumferential direction along the projection 111 of the slide frame 110.

With reference to FIG. 2, a cam pin 102 is secured to the slide frame 110 through a cam groove 52B of the inner cylinder 52. The lower portion of the slide frame 110 is formed to have the pedestal 114 extending toward the side of the image sensor 11. The pedestal 114 is formed to have a rack 115. A pinion 116 is in mesh with teeth 115A formed in the rack 115. The shaft of the above-mentioned motor 20A is secured to the pinion 116.

The motor 20A is secured to the inner wall 52A of the inner cylinder 52. Since the pinion 116 rotates and the rack 115 moves along the optical axis L, the lens holding body 80 and rotary body 90 move along the direction of the optical axis L. Since the motor 20A is secured to the inner wall 52A of the inner cylinder 52, the motor 20A does not move with the rack 115 (pedestal 114) move; only the lens holding body 80 and rotary body 90 move along the direction of the optical axis L.

The driving circuit 19A, zoom motor 20A and control circuit 40 serve as a zoom lens group driving mechanism which, in response to a zoom command, moves along the optical axis at least one zoom lens group from among the multiple zoom lens groups included in the zoom optical system 5. Further, the lens holding frame 82 (lens holding body 80), ring 92 (rotary body 90), motor 100 and gear wheel 101 constitute a lens tilting mechanism for tilting at least one lens of two or more lenses, which constitute a lens group, in such a manner that the lens 81 is, tilted with respect to the optical axis L of the zoom lens barrel 50.

A lens fixing frame 72 whose inner peripheral surface has been secured to the outer peripheral surface of a lens 71 is attached to the outer peripheral surface of the lens 71. One end portion of each of a plurality of pins 70 is secured to the lens fixing frame 72. The other end portion of each pin 70 resides inside a cam groove 73 formed in the zoom lens barrel 50. The lens fixing frame 72 (lens 71) can be moved along the direction of the optical axis L by moving the pins 70 along the cam groove 73.

A portion of the lens fixing frame 72 is formed to have a rack 77 projecting along the optical axis L. A pinion 78 is in mesh with teeth 77A formed in the rack 77. The shaft of the above-mentioned motor 20A is secured to the pinion 78. When the motor 20A is driven, the pinion 78 rotates and the rack 77 moves along the direction of the optical axis L and, hence, so does the lens 71.

Although the motor 20A that drives the lens 71 along the optical axis L and the motor 20A that drives the lens 81 along the optical axis L are designated by identical reference characters, it goes without saying that each of these motors 20A can be driven independently of the other and that the lens 71 and lens 81 can be driven along the optical axis L over different distances.

The lens 71 and lens 81 are lenses that constitute the variable power lens 3 and corrective lens 4, which construct the zoom optical system 5 as mentioned above.

As described above with reference to FIGS. 4 and 5, the end face 85 of the lens holding frame 82 is formed to have the protrusions and cavities 87 and the end face 85 is tensioned by the tension spring 117 so as to come into contact with the protrusion 93 formed on the ring 92. When the ring 92 is turned and the protrusion 93 comes into contact with a protrusion of the protrusions and cavities 87 projecting in the direction of the image sensor 11, the lens holding body 80 tilts toward the side of the subject about the axis A2 (see FIG. 5). When the ring 92 is turned and the protrusion 93 penetrates a cavity of the protrusions and cavities 87, the lens holding body 80 tilts toward the side of the image sensor 11 about the axis A2. Thus, the lens 81 can be tilted through prescribed tilt angles. The lens holding body 80 and rotary body 90 serve as a cam mechanism that tilts at least one lens at a tilt angle that corresponds to the zoom magnification (namely a cam mechanism that tilts at least one lens about the first axis A1 at the first tilt angle corresponding to the zoom magnification and at least one lens about the second axis A2 at the second tilt angle corresponding to the zoom magnification). Although the end face 85 of the lens holding frame 82 is formed to have the protrusions and cavities 87, the end face 95 of the ring 92 may just as well be formed to have the protrusions and cavities 87. In such case the protrusion 93 would be formed on the end face 85 of the lens holding frame 82.

With reference to FIG. 6, the protrusion 93, rather than being provided on the upper portion of the ring 92, may just as well be provided (as a protrusion 93A) at a position on the ring 92 that is at an angle of 90 degrees from the protrusion 93 in the clockwise direction (or counter-clockwise direction) when viewed from the front. It can be understood that, if the protrusion 93A is thus provided at the position on the ring 92 that is at an angle of 90 degrees in the clockwise direction when viewed from the front, then, by turning the ring 92 through just a small angle in the manner described above, the protrusion 93A will penetrate the portion of protrusions and cavities 87 (in the case of a cavity) or will push the portion of the protrusions and cavities 87 (in the case of a protrusion), thereby tilting the lens not only about the axis A2 but also about the axis A1.

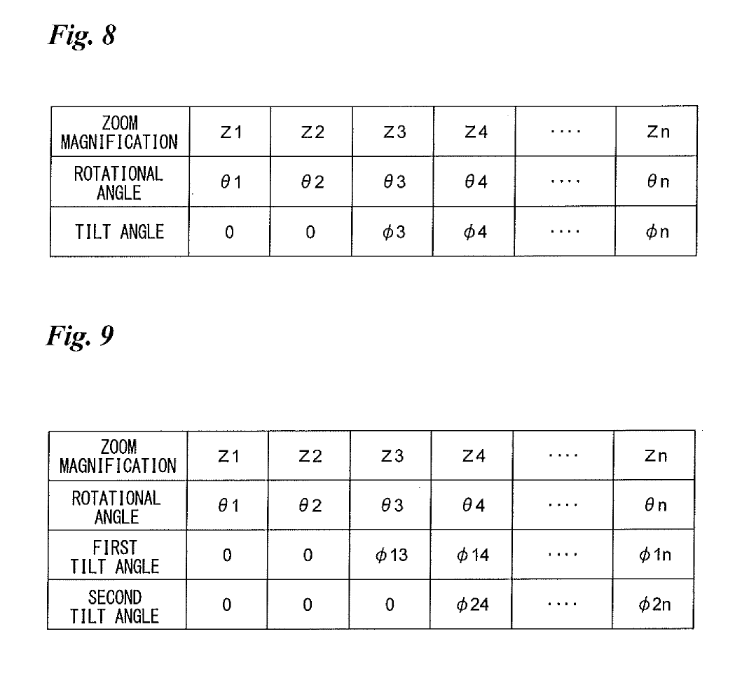

FIG. 8 is a table illustrating the relationship among zoom magnification, rotational angle and tilt angle.

The rotational angle shown in FIG. 8 is the angle of rotation of the ring 92. A reference position in the direction of rotation of the ring 92 has also been predetermined in correspondence with a reference position along the direction of the optical axis L. The tilt angle is that in a case where the protrusion 93 has been formed at the upper portion of the ring 92 as described above (the pitch angle through which tilting takes place about the axis A2). The table shown in FIG. 8 has been stored in the memory 42.

In this embodiment, when a zoom command is supplied from the zoom button 46, the ring 92 is caused to rotate through a rotational angle that corresponds to a zoom magnification conforming to the zoom command. When the ring 92 rotates, the lens 81 tilts in accordance with the angle of rotation of the ring 92, as described above. For example, in a case where zoom magnifications arc Z1 and Z2 (low zoom magnification), the rotational angles are □1 and □2, respectively, and each tilt angle is zero. That is, in the case of low zoom magnification, the lens 81 is not tilted. If the zoom magnification is made Z3, the ring 92 is rotated through an angle of □3 and the lens 81 is tilted through an angle of □3. Operation is similar with regard to other zoom magnifications.

Tilt angle is predetermined in such a manner that astigmatism will diminish in a case where the lens 81, etc. is moved along the direction of the optical axis L at a designated zoom magnification. Astigmatism can be reduced irrespective of zoom magnification.

FIG. 9 is a table illustrating the relationship among zoom magnification, rotational angle, first tilt angle and second tilt angle.

The rotational angle shown in FIG. 9 also is the angle of rotation of the ring 92. A reference position in the direction of rotation of the ring 92 has also been predetermined in correspondence with a reference position along the direction of the optical axis L. Unlike the case described above, this is a case where the protrusion 93 has not been formed on the upper portion of the ring 92 but instead is the case where the protrusion 93A has been formed at the position that is 90 degrees clockwise from the upper portion of the ring 92. The first tilt angle indicates the yaw angle through which tilting takes place about the axis A1, and the second tilt angle is the pitch angle through tilting take place about the axis A2. The table shown in FIG. 9 also has been stored in the memory 42.

In this case as well, when a zoom command is supplied from the zoom button 46, the ring 92 is caused to rotate through a rotational angle that corresponds to a zoom magnification conforming to the zoom command. When the ring 92 rotates, the lens tilts at the first Lilt angle about the axis A1 and at the second Lilt angle about the axis A2 in accordance with the angle of rotation of the ring 92. For example, in a case where zoom magnifications are Z1 and Z2 (low zoom magnification), the rotational angles are □1 and □2, respectively, and the first and second tilt angles are both zero. Here also, in the case of low zoom magnification, the lens 81 is not tilted. If the zoom magnification is made Z3, the ring 92 is rotated through the angle of □3 and the lens 81 is tilted at the first Lilt angle, which is □13, and at the second tilt angle, which is zero. If the zoom magnification is made Z4, the lens 81 is tilted at the first tilt angle, which is □14, and at the second tilt angle, which is □24. Operation is similar with regard to other zoom magnifications.

Tilt angle is predetermined in such a manner that astigmatism will diminish in a case where the lens 81, etc. is moved along the optical axis L at a designated zoom magnification. In this case, the lens 81 can be tilted about the axis A1 and not just about the axis A2. As a result, astigmatism can be reduced more accurately irrespective of zoom magnification.

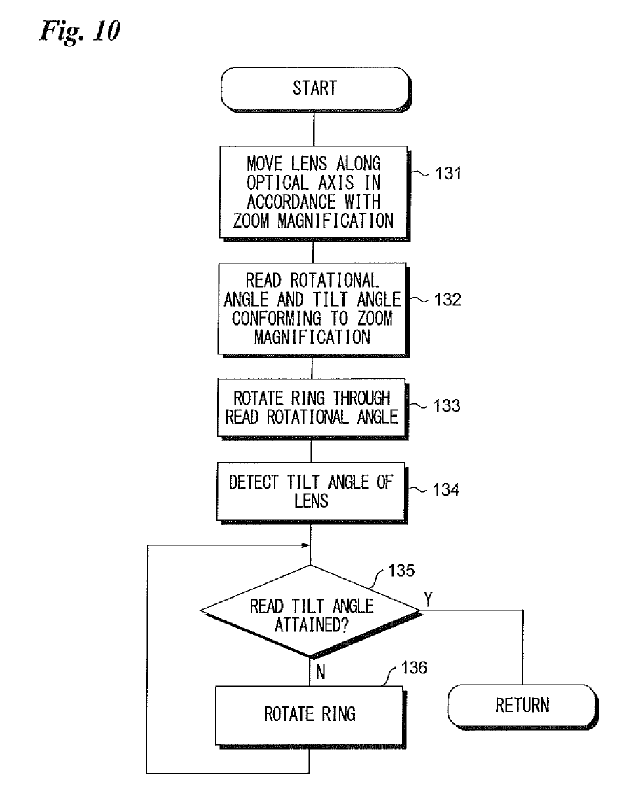

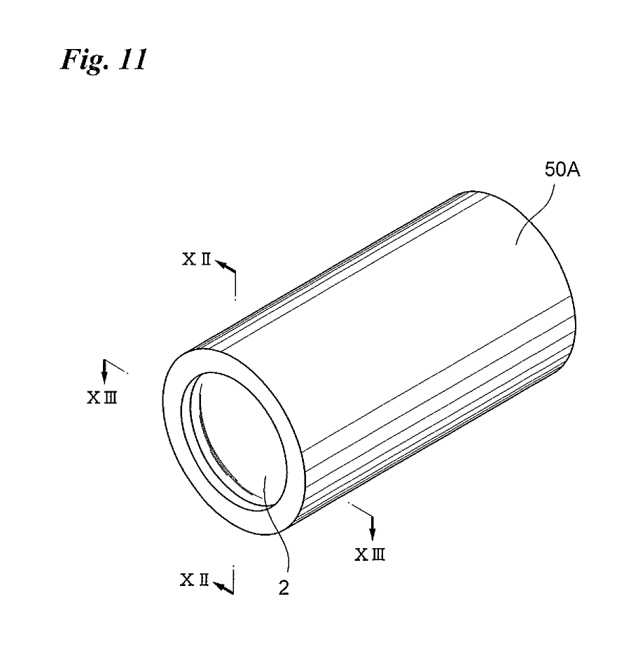

FIG. 10 is a flowchart illustrating processing executed by the TV camera lens 1.

When a zoom command is supplied from the zoom button 46, the lens 81, etc. is positioned along the optical axis L by the motor 20A, etc. so as to attain a zoom magnification that is in accordance with the zoom command (step 131). Further, rotational angle and tilt angle stored in the table (see FIGS. 8 and 9), which has been stored in the memory 42, are read (step 132) and the ring 92 is rotated through the read rotational angle by the motor 20B (step 133).

The tilt angle of the lens 81 is detected by the angle detecting sensor 88A (step 134) and it is determined whether the detected tilt angle is the tilt angle that has been read from the table (step 135). If the detected tilt angle is not the tilt angle read from the table (“NO” at step 135), the ring 92 is rotated (step 136). The processing of steps 135 and 136 is repeated until the detected tilt angle becomes the tilt angle that has been read from the table. When the detected tilt angle becomes the tilt angle read from the table (“YES” at step 135), processing is quit and processing such as shooting and recording of the subject is carried out.

In the foregoing embodiment, a case where the lens 81 is tilted about the axis A2 has been described. However, in a case where the lens 81 is tilted about the axis A1 and the axis A2, the first and second tilt angles are read, the yaw angle of the lens 81 is detected by the first angle detecting sensor 88A and the pitch angle of the lens 81 is read by the second angle detecting sensor 88B. The ring 92 is rotated in such a manner that the read yaw angle becomes the first detection angle read from the table and the read pitch angle becomes the second detection angle read from the table. Thus, the control circuit 40 (control mechanism) controls the lens tilting mechanism, the detection angle detected by the first angle detecting sensor 88A is made the first tilt angle corresponding to the zoom magnification, and the detection angle detected by the second angle detecting sensor 88B is made the second tilt angle corresponding to the zoom magnification.

FIGS. 11 to 16 illustrate another embodiment.

In the above-described embodiment, the lens 81 is tilted utilizing a cam. In the embodiment described next, however, an annular frame is further provided on the outer side of a lens holding frame, thereby enabling the lens 81 to be tilted about two axes that are perpendicular to the optical axis L of the zoom lens barrel 50 in a manner similar to that described above.

FIG. 11 illustrates the external appearance of a zoom lens barrel 50A. The zoom lens barrel 50A, which corresponds to the zoom lens barrel 50 described above, includes the components such as the zoom optical system 5 within the zoom lens barrel 50A.

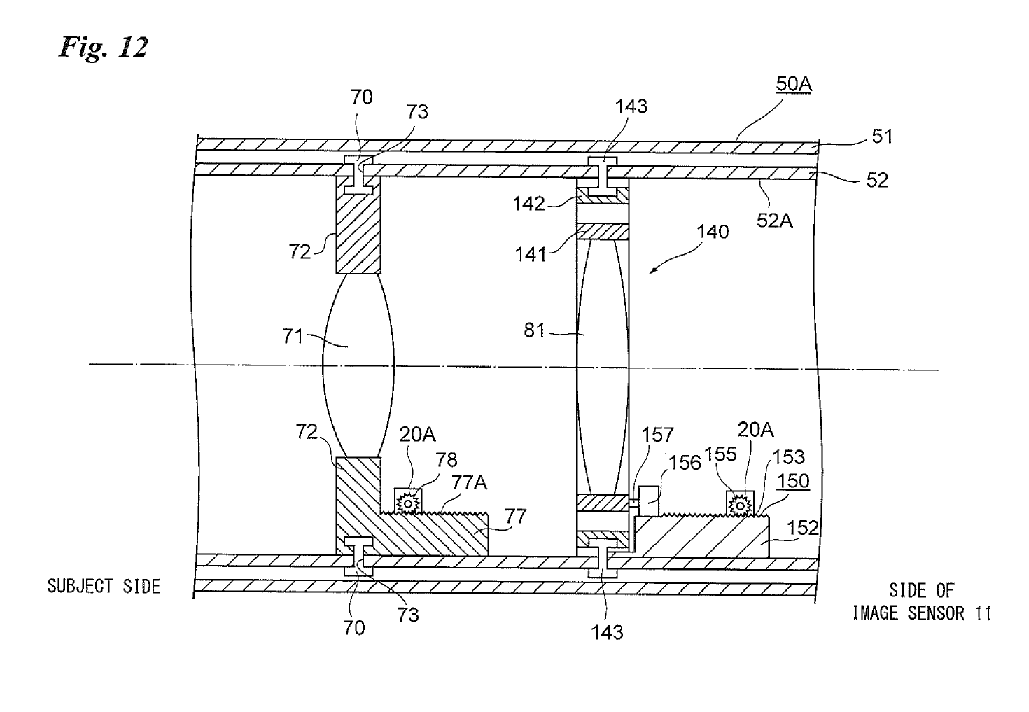

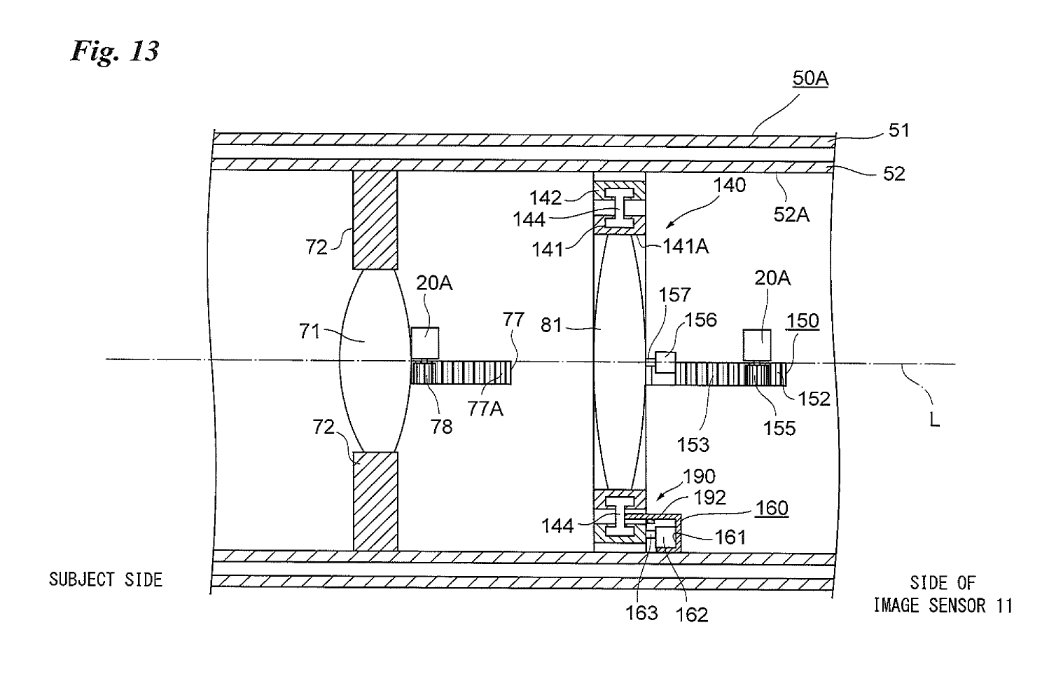

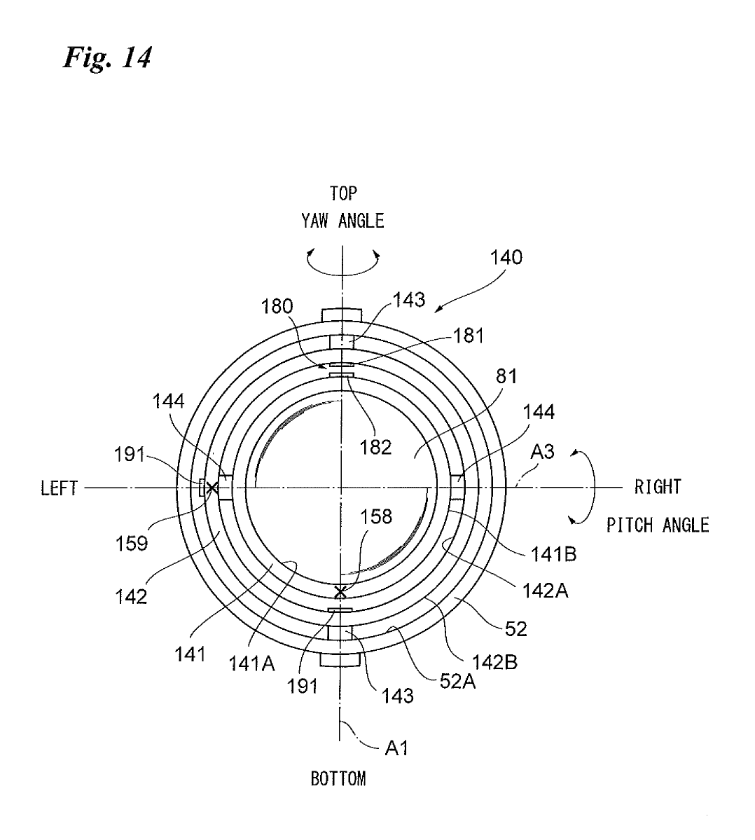

FIG. 12 is a sectional view taken along line XII-XII of FIG. 11, FIG. 13 a sectional view taken along line XIII-XIII of FIG. 11, and FIG. 14 a back view of a lens holding body 140, which is included within the zoom lens barrel 50A, when viewed from the side of the image sensor 11. Components in FIGS. 12 to 14 identical with those shown in FIG. 1 or 2 are designated by like reference characters and need not be described again.

With reference primarily to FIG. 14, the lens 81 is held by a first lens holding frame 141 for holding the lens 81. Positioned outside the first lens holding frame 141 is an annular second lens holding frame 142 in the interior of which the first lens holding frame 141 is positioned. A pin 144 passes, in a freely rotatable manner, through the first lens holding frame 141 and second lens holding frame 142 at a portion of a side face 141A on the outer side of the first lens holding frame 141 on axis A3 along the horizontal direction when viewed from the back, and at a portion of a side face 142A on the inner side of the second lens holding frame 142 on axis A3 along the horizontal direction. The first lens holding frame 141 holds at least one lens 81 is a manner freely tiltable about the axis A3 (first axis). The second lens holding frame 142 holds the first lens holding frame 141 in a manner freely tiltable at a portion on the axis A3 (first axis). The axis A3 (first axis) and the axis A1 (second axis) are both orthogonal to the optical axis L of the zoom lens barrel 50 and are orthogonal to each other.

A pin 143 passes, in a freely rotatable manner, through the second lens holding frame 142 and inner cylinder 52 at a portion of a side face 142B on the outer side of the second lens holding frame 142 on axis A1 along the vertical direction when viewed from the back, and at a portion of the inner wall 52A of the inner cylinder 52. The second lens holding frame 142 is freely tiltable about axis A1 (second axis).

With reference to FIG. 12, a pedestal 150 extending toward the side of the image sensor 11 is formed within the zoom lens barrel 50A at the lower portion thereof. The end portion of the pedestal 150 on the subject side is secured to the above-mentioned pin 143. The second lens holding frame 142 therefore tilts without the pin 143 rotating. The pedestal 150 is formed to have a rack 152. A pinion 155 is in mesh with teeth 153 formed in the rack 152. The shaft of the above-mentioned motor 20A is secured to the pinion 155. The motor 20A is secured to the inner wall of the inner cylinder 52 and is not placed on the pedestal 150. When the shaft of the motor 20A rotates, the pinion 155 rotates and the pedestal 150 moves along the direction of the optical axis L. The end portion of the pedestal 150 on the subject side is secured to the pin 153. Therefore, when the pedestal 150 moves along the direction of the optical axis L, the lens holding body 140 also moves along the optical axis L together with pedestal 150.

A linear motion mechanism 156 (first linear motion mechanism) is disposed on the upper portion of the pedestal 150 on the subject side. A motor (not shown) is included inside the linear motion mechanism 156. When the shaft of this motor rotates, a shaft 157 of the linear motion mechanism 156 moves along the direction of the optical axis L. One end portion of the shaft 157 is secured to the lower end of the first lens holding frame 141 of lens holding body 140 on the axis A1 (the fixed portion is indicated at numeral 158 in FIG. 14). By moving the shaft 157 toward the subject side in FIG. 12, the portion indicated at 158 in FIG. 14 is pushed by the shaft 157 and the lower end of the first lens holding frame 141 tilts in the forward direction in FIG. 14 about the axis A3. (The lower end tilts about the axis A3 in the clockwise direction in FIG. 12. The upper end of the first lens holding frame 141 tilts rearward in FIG. 14.) Conversely, by moving the shaft 157 toward the side of the image sensor 11 in FIG. 12, the portion indicated at 158 in FIG. 14 is pulled by the shaft 157 and the lower end of the first lens holding frame 141 tilts in the forward direction in FIG. 14 about the axis A3. (The lower end Lilts about the axis A3 in the counter-clockwise direction in FIG. 12. The upper end of the first lens holding frame 141 tilts forward about the axis A3 in FIG. 14.)

With reference to FIG. 13, on the left side within the zoom lens barrel 50A when the subject side is viewed from the side of the image sensor 11, a housing 160 is provided at a position where it contacts the inner wall 52A of the inner cylinder 52. The end portion of the housing 160 on the subject side is secured to the pin 144. The first lens holding frame 141 and second lens holding frame 142 tilt without the pin 144 rotating, as in the case of the pin 143. When the lens holding body 140 moves along the direction of the optical axis L, the housing 160 also moves along the direction of the optical axis L together with the lens holding body 140. Formed within the housing 160 is a space 161 in which a linear motion mechanism 162 (second linear motion mechanism) is placed. Also included inside the linear motion mechanism 162 is a motor (not shown). When the shaft of this motor rotates, a shaft 163 of the linear motion mechanism 162 moves along the direction of the optical axis L. One end portion of the shaft 163 is secured to the left end portion (the left side from the side of the image sensor 11 toward the subject side) of the second lens holding frame 142 of the lens holding body 140 on the axis A3 (the fixed portion is indicated at numeral 159 in FIG. 14). By moving the shaft 163 toward the subject side in FIG. 13, the portion indicated at 159 in FIG. 14 is pushed by the shaft 163 and the left end of the second lens holding frame 142 moves in the rearward direction in FIG. 14 about the axis A1. (The left end tilts about the axis A1 in the clockwise direction in FIG. 13. The right end of the second lens holding frame 142 tilts forward in FIG. 14.) Conversely, by moving the shaft 163 toward the side of the image sensor 11 in FIG. 13, the portion indicated at 159 in FIG. 14 is pulled by the shaft 163 and the left end of the second lens holding frame 142 tilts in the forward direction in FIG. 14 about the axis A1. (The left end tilts about the axis A1 in the counter-clockwise direction in FIG. 13. The right end of the second lens holding frame 142 tilts rearward about the axis A1 in FIG. 14.)

Thus the lens 81 is supported by the pin 143 or 144 (a supporting member supporting at least one lens at one end thereof in freely swinging fashion) and the first linear motion mechanism 156 or second linear motion mechanism 162 (linear motion mechanism) moves a portion of the lens except for the one end portion thereof provided with the pin 143 or 144 along the direction of the optical axis L, whereby the at least one lens 81 can be tilted, with the pin 143 or 144 (supporting member) serving as the fulcrum, at a tilt angle corresponding to the zoom magnification. Further, owing to the fact that the at least one lens 81 is moved along the direction of the optical axis L at a first portion thereof (the portion indicated at 158 in FIG. 14), which is different from the portion thereof on axis A3 (first axis), by the first linear motion mechanism 156, the lens 81 it tilted at the first tilt angle that corresponds to the zoom magnification. Owing to the fact that the at least one lens 81 is moved along the direction of the optical axis L at a second portion thereof (the portion indicated at 159 in FIG. 14), which is different from the portion thereof on axis A1 (second axis), by the second linear motion mechanism 162, the lens 81 is tilted at the second tilt angle that corresponds to the zoom magnification.

With reference to FIG. 14, a magnet 181 and a Hall IC (Integrated′. Circuit) 182, which constitute a first angle detection sensor 180, is mounted between side face 141A on the outer side of the first lens holding frame 141 and side face 142B on the inner side of the second lens holding frame 142 on axis A1. The first tilt angle (yaw angle) of the lens 81 is detected by the first angle detection sensor 180. Further, a magnet 191 constituting a second angle detecting sensor 190 is mounted on side face 142B on the outer side of the second lens holding frame 142 on axis A3. Furthermore, with reference to FIG. 13, a Hall IC 192 constituting the second angle detecting sensor 190 is mounted on the housing 160.

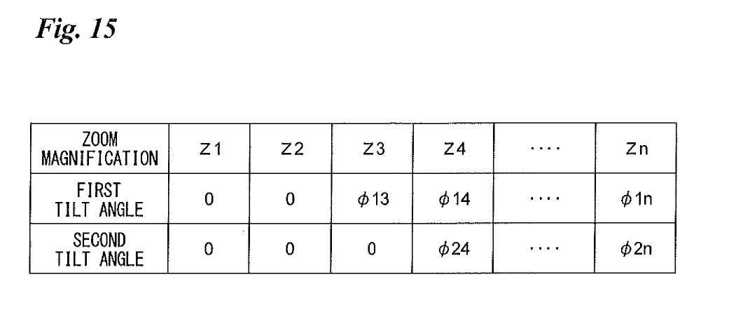

FIG. 15 is a table illustrating the relationship among zoom magnification, first tilt angle and second Lilt angle.

The first tilt angle shown in FIG. 15 is a tilt angle (pitch angle) through which the lens 81 tilts about the axis A3 shown in FIG. 14. The second tilt angle is a tilt angle (yaw angle) through which the lens 81 tilts about the axis A1 shown in FIG. 14.

In this embodiment, when a zoom command is supplied from the zoom button 46, the above-mentioned linear motion mechanisms 156 and 162 are controlled by the control circuit 40 in such a manner that the lens 81 is tilted at the first and second tilt angles corresponding to the zoom magnification that is in accordance with the zoom command. For example, in a case where zoom magnifications are Z1 and Z2 (low zoom magnification), the first and second tilt angles are each zero. That is, in the case of low zoom magnification, the lens 81 is not tilted. If the zoom magnification is made Z3, the first tilt angle is φ13 and the second tilt angle is zero. If the zoom magnification is made Z4, the first tilt angle is φ14 and the second tilt angle is φ24. Operation is similar with regard to other zoom magnifications.

The first and second tilt angles are also predetermined in such a manner that astigmatism will diminish in a case where the lens 81, etc. is moved along the direction of the optical axis L at a designated zoom magnification. Astigmatism can be reduced irrespective of zoom magnification.

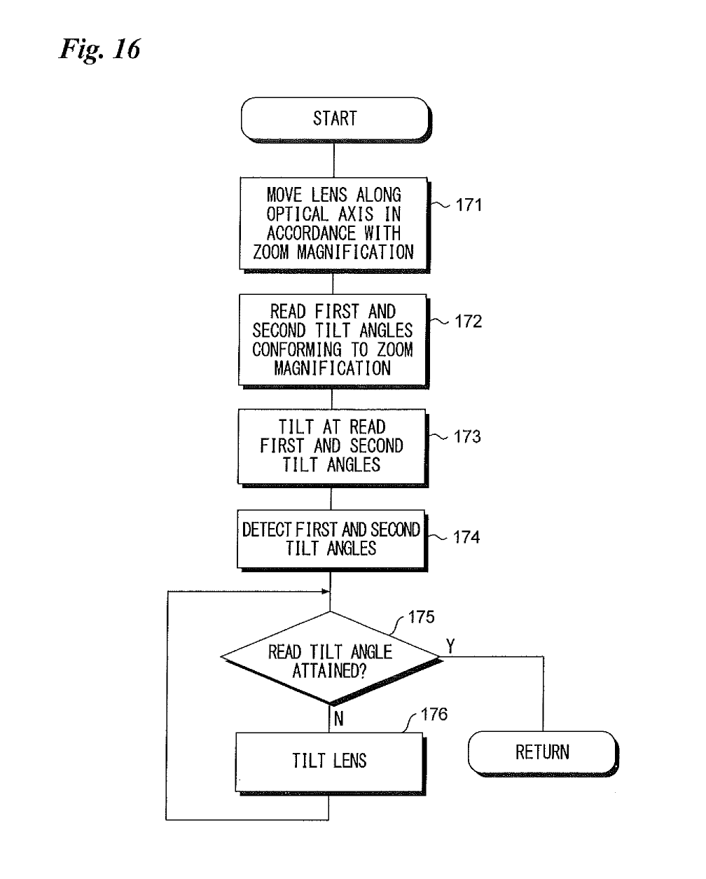

FIG. 16 is a flowchart illustrating processing executed by the TV camera lens 1.

When a zoom command is supplied from the zoom button 46, the lens 81, etc. is positioned along the direction of the optical axis L by the motor 20A, etc. so as to attain a zoom magnification that is in accordance with the zoom command (step 171). Further, from among the first and second tilt angles that have been stored in the table (see FIG. 15) stored in the memory 42, first and second tilt angles corresponding to the zoom magnification are read by the control circuit 40 (step 172). Further, the lens 81 is tilted by the linear motion mechanisms 156 and 162 in such a manner that the lens takes on the first and second tilt angles that have been read (step 173).

The first Lilt angle (the tilt angle about the axis A3) of the lens 81 is detected by the first angle detection sensor 180 and the second tilt angle (the tilt angle about the axis A1) of the lens 81 is detected by the second angle detecting sensor 190 (step 174). It is determined by the control circuit 40 whether the detected first tilt angle is the first tilt angle that has been read from the table and whether the detected second tilt angle is the second tilt angle that has been read from the table (step 175). If the detected first tilt angle is not the first tilt angle read from the table and the detected second tilt angle is not the first tilt angle read from the table (“NO” at step 175), then the lens 81 is tilted in such a manner that the detected first tilt angle becomes the first tilt angle that has been read from the table and the detected second tilt angle becomes the second tilt angle that has been read from the table (step 176). When the detected first tilt angle becomes the first tilt angle that has been read from the table and the detected second tilt angle becomes the second tilt angle that has been read from the table, processing is quit.

There are cases where the image sensor 11 is skewed such that the optical axis of the zoom lens barrel 50 or 50A is not its normal line. In such cases, it may be arranged so that the lens 81 is tilted so as to alleviate the adverse effects of skew of the image sensor 11 that accompany a change in zoom magnification.

In the foregoing embodiment, a case where the lens 81 is tilted about the axis A2 is described. However, it may be arranged so as to tilt a lens within the master optical system 10 situated between the diaphragm 6 and image-forming plane of the subject (the photoreceptor surface of the image sensor 11). Further, a plurality of lens tilting mechanisms may be provided.

Further, in the foregoing embodiment, the first lens holding frame 141 and second lens holding frame 142 are fixed, as a result of which the lens 81 tilts about the axis A3. In this case, the first lens holding frame 141 would be pushed and pulled along the direction of the optical axis L by the first linear motion mechanism 156.

As many apparently widely different embodiments of the present invention can be made without departing from the spirit and scope thereof, it is to be understood that the invention is not limited to the specific embodiments thereof except as defined in the appended claims.

What is claimed is:

1. A zoom lens apparatus that includes multiple lens groups each constituted by two or more lenses, comprising:
a lens tilting mechanism for tilting at least one lens of the two or more lenses constituting the lens group;
a lens-group driving mechanism for moving at least one lens group, among the multiple lens groups included in the zoom lens apparatus, along the direction of an optical axis of the zoom lens apparatus in accordance with zoom magnification; and
a control mechanism for causing said lens tilting mechanism to tilt the at least one lens at a tilt angle that corresponds to the zoom magnification.

2. The apparatus according to claim 1, further comprising a tilt-angle detection device for detecting the tilt angle of the at least one lens tilted by said lens tilting mechanism;
wherein said control mechanism controls said lens tilting mechanism in such a manner that the tilt angle detected by said tilt-angle detection device takes on a tilt angle that corresponds to the zoom magnification.

3. The apparatus according to claim 1, wherein said control mechanism has a cam mechanism for tilting the at least one lens at the tilt angle that corresponds to the zoom magnification.

4. The apparatus according to claim 3, wherein said cam mechanism includes:
a lens holding frame for holding the at least one lens; and
a ring, which has a surface in contact with the surface of said lens holding frame and rotates through a rotational angle, which corresponds to the zoom magnification, about the optical axis of the zoom lens apparatus;
wherein at least one of the surface of said lens holding frame or surface of said ring has a cam for providing said lens holding frame with motion that tilts the at least one lens at the tilt angle that corresponds to the zoom magnification.

5. The apparatus according to claim 1, wherein said lens tilting mechanism tilts the at least one lens about an axis which is at least one of a first axis and a second axis that are both orthogonal to the optical axis of the zoom lens apparatus and orthogonal to each other; and
said control mechanism controls said lens tilting mechanism to thereby tilt the at least one lens about the first axis at a first tilt angle that corresponds to the zoom magnification and tilt the at least one lens about the second axis at a second tilt angle that corresponds to the zoom magnification.

6. The apparatus according to claim 5, further comprising:
a first tilt-angle detection device for detecting the tilt angle of the at least one lens tilted by said lens tilting mechanism about the first axis; and
a second tilt-angle detection device for detecting the tilt angle of the at least one lens tilted by said lens tilting mechanism about the second axis;
wherein said control mechanism, by controlling said lens tilting mechanism, adopts the detection angle, which has been detected by said first tilt-angle detection device, as the first tilt angle that corresponds to the zoom magnification, and by controlling said lens tilting mechanism, adopts the detection angle, which has been detected by said second tilt-angle detection device, as the second tilt angle that corresponds to the zoom magnification.

7. The apparatus according to claim 5, wherein said control mechanism has a cam mechanism for tilting the at least one lens about the first axis at the first Lilt angle that corresponds to the zoom magnification and tilting the at least one lens about the second axis at the second tilt angle that corresponds to the zoom magnification.

8. The apparatus according to claim 7, wherein said cam mechanism includes:
a lens holding frame for holding the at least one lens; and
a ring, which has a surface in contact with the surface of said lens holding frame and rotates through a rotational angle, which corresponds to the zoom magnification, about the optical axis of said zoom lens apparatus;
wherein at least one of the surface of said lens holding frame or surface of said ring has a cam for providing said lens holding frame with motion that tilts the at least one lens about the first axis at the first tilt angle that corresponds to the zoom magnification and that tilts the at least one lens about the second axis at the second tilt angle that corresponds to the zoom magnification.

9. The apparatus according to claim 5, wherein said lens tilting mechanism has:
a first lens holding frame freely tiltable about the first axis for holding the at least one lens; and
a second lens holding frame holding said first lens holding frame in a freely tiltable manner at a portion on the first axis, and being freely tiltable about the second axis.

10. The apparatus according to claim 1, wherein a plurality of said lens tilting mechanisms are provided.

11. The apparatus according to claim 1, further comprising a supporting member for supporting the at least one lens at one end thereof in freely swinging fashion;
wherein said control mechanism includes a linear motion mechanism which, by moving the at least one lens along the direction of the optical axis, tilts the at least one lens at the tilt angle that corresponds to the zoom magnification, with said supporting member serving as a fulcrum.

12. The apparatus according to claim 5, wherein said control mechanism includes:
a first linear motion mechanism for tilting the at least one lens about the first axis at the first tilt angle that corresponds to zoom magnification by moving the at least one lens along the direction of the optical axis at a first portion thereof different from a portion thereof on the first axis; and
a second linear motion mechanism for tilting the at least one lens about the second axis at the second tilt angle that corresponds to zoom magnification by moving the at least one lens along the direction of the optical axis at a second portion thereof different from a portion thereof on the second axis.

13. The apparatus according to claim 1, wherein the at least one lens is situated between a diaphragm and an image forming plane of a subject.

14. A method of controlling a zoom lens apparatus that includes multiple lens groups each constituted by two or more lenses, comprising steps of:
a lens tilting mechanism tilting at least one lens of the two or more lenses constituting the lens group;
a lens-group driving mechanism moving at least one lens group, among the multiple lens groups included in the zoom lens apparatus, along the direction of an optical axis of the zoom lens apparatus in accordance with zoom magnification; and
a control mechanism causing the lens tilting mechanism to tilt the at least one lens at a tilt angle that corresponds to the zoom magnification.
